(19) United States
(12) Patent Application Publication
(10) Pub. No.: US 2011/0298222 A1
(43) Pub. Date: Dec. 8, 2011

(54) Electric power generation from moving vehicles

(76) Inventors: Matthew R. Bailey, Lakeway, TX (US); Jacob B. Angelo, Lakeway, TX (US); Michael L. Gotcher, Austin, TX (US)

(21) Appl. No.: 12/802,347

(22) Filed: Jun. 4, 2010

(51) Int. Cl. H02K 7/18

(52) U.S. Cl. 290/1 R

(57) ABSTRACT

A system of embedded cylindrical rollers is mounted in an underground containment system in spaced transverse channels beneath a road surface. Power is generated from the passage of motor vehicles over the rollers converting rotary energy into electrical energy. Each roller is designed as a power generator which can be networked together to produce electrical energy directly to a storage battery or grid, thereby eliminating the need to couple the roller to an external generator as in prior art. The system activates when the vehicles contact the embedded rollers in a prescribed direction, and transfer vehicular movement into rotational motion, thus generating electrical energy produced insitu without the need for an external generator.

### REFERENCES CITED

| | | |
|---|---|---|
| 3,885,163 | May 1975 | Toberman |
| 4,247,785 | January 1981 | Apgar |
| 6,767,161 B1 | July 2004 | Calvo et al. |

### BACKGROUND OF THE INVENTION

The present invention relates to an underground roller system principally designed as a power generator to convert wasted rotational energy from vehicles moving over a road surface into useful electrical energy. Various common methods of generating electricity have been proposed including renewable sources of power such as solar and wind. These methods require a lot of new equipment which is costly. In addition, they utilize large areas of land with special requirements of sun and wind.

Using city streets and highways as a means of power generation provides a way to produce inexpensive power for extended time periods. Millions of vehicles travel over roads all over the world. The energy from these moving vehicles can be effectively harnessed for producing electricity. Devising a safe, effective and inexpensive means to convert the energy of moving vehicles into clean energy would supplement and/or reduce the need for utilities to produce electricity from expensive conventional methods.

Other inventions attempting to harness the energy of moving vehicles have been proposed, but they all suffer from different drawbacks as discussed by Calvo in 2004, U.S. Pat. No. 6,767,161 B1. Calvo's invention itself suffers from a complex mechanism of moving parts. These parts include actuators, cocking arms, trigger bars, locking bars and sensor rings, as well as a flywheel, gearbox, speed brake and turbine for generating power. Calvo's invention couples with an external generator to produce electrical energy.

Another means for using an underground system of rollers to generate electricity from moving vehicles has been proposed as disclosed by Toberman in 1975, U.S. Pat. No. 3,885,163. This patent uses rollers in open trenches cut transversely across the road. The rollers are placed such that the tires of the vehicle passing there over make frictional contact with and cause the rollers to spin. Electrical generators coupled to the shafts of the rollers change rotational energy of the rollers into electrical energy. This invention has several drawbacks as discussed by Apgar in 1981, U.S. Pat. No. 4,247,785; small bumps felt by motorist going over the hard roller, potential roller bearing damage from continuous impact of vehicles and open roller trenches filling with water and debris. As another example, there is loss of rotational energy through couplings and gears when a single roller is attached to an external generator. Moreover, the use of multiple rollers connected in series to the same shaft, spin only one external generator consuming more rotational energy, but not producing more power compared to a single roller connected to an external generator.

A similar invention by Apgar in 1981, U.S. Pat. No. 4,247,785, utilizes a series of magnetized rollers each in a totally enclosed structure under the road which obviates some of the drawbacks of the prior art. When vehicles, largely made of magnetic materials, or enhanced by external magnets mounted in the vehicle body, move across the magnetized rollers they create a turning moment on the roller, causing rotation, due to a distortion of the magnetic field. The invention is primarily designed for use on freeway off ramps, and requires a series of different sized rollers to convert vehicle energy into rotational energy. As in the prior art, each sized roller is coupled to an external generator which requires more hardware and limits its power output.

### SUMMARY OF THE INVENTION

A single common disadvantage with the above prior art is the use of multiple transverse rollers to power a single generator, or multiple rollers each coupled to a single power generator. This not only requires a lot of equipment, but it restricts the amount of produced power from each revolution of the roller, and multiplies the frictional energy losses through the use of shafts and gears.

The present invention expands upon the prior art by designing and utilizing the underground roller as the generator to produce the desired electric power output insitu as it rotates. This is a major advantage of the present invention. By combining the generator within the roller, a bigger generator can built to deliver directly more electrical power for the same number of roller revolutions with less equipment and less frictional losses than in the prior art. This design would accommodate the majority of roadway applications. Each roller-generator is independent and not connected to a single generator.

The cylindrical roller-generator combination and its structural enclosure can be fabricated using optimal mechanical designs, incorporated with modern electrical generator designs, to improve safety features and other drawbacks addressed in the prior art. Generated electric power is delivered directly to a storage battery or a power grid without the need for an externally coupled generator, thus minimizing the amount of equipment and the number of moving parts.

After reviewing the prior art, the following criteria were considered important in the design basis for this invention: safe environmentally friendly design, low cost, high power output, underground containment, rugged strong construction materials, road surface compatibility, minimum equipment components and maintenance, convenient equipment installation and replacement, corrosion and weather (heat, cold, snow, rain, sun) resistant.

### DESCRIPTION OF DRAWINGS

FIG. 1 is a representation of a roadway within which friction roller-generators have been installed underneath the road in transverse channels to convert vehicle motion into electrical power delivered to a battery and/or power grid.

FIG. 2 is an elevation of the roadway showing frictional roller-generators installed therein, and demonstrating the manner in which undesirable water and sediment is carried away from the roller by an underground containment system to natural drainage along the side of the roadway.

FIG. 3 is a cross sectional view of the friction roller-generator of this invention.

FIG. 4 is a representation of a single friction roller-generator with multiple support hubs separating multiple armatures.

FIG. 5 is a cross sectional view of the friction roller-generator of this invention within a partially encased channel embedded in a roadway. This is similar to U.S. Pat. No. 3,885,165, but instead of using a separate roller and external generator, this invention utilizes a roller with a built-in generator to produce electrical power directly.

FIG. 6 is a cross-sectional view of a magnetized version of the cylindrical roller-generator within a totally encased channel embedded in a roadway. This is similar to U.S. Pat. No. 4,247,785, but instead of using a separate roller and external generator, this invention utilizes a roller with a built-in generator to produce electrical power directly.

### DESCRIPTION OF INVENTION

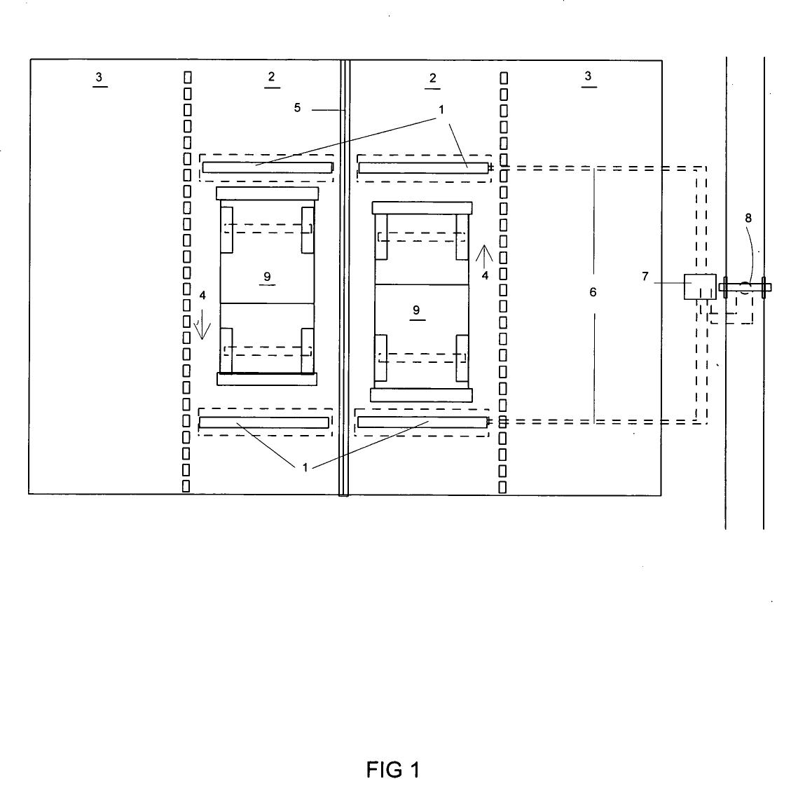

FIG. 1 illustrates this invention wherein vehicles (9) moving along a divided roadway (5), in either direction of traffic flow (4), convert linear motion into rotational energy by a friction-roller generator (1) which produces electrical power. More preferably, the roller and electrical generator are designed and fabricated as a single unit to convert the rotational energy into electricity. This design eliminates the need for an external generator coupled to the roller as in the prior art, and maximizes the amount of power produced per revolution of the roller. The roller-generator (1) produces direct current which is transmitted by power leads (6) to an electrical device (7), such as a storage battery and/or converted to alternating current using an electrical inverter. The generated power is either delivered to a nearby battery (7) or power grid (8), or used locally if electrical power is not available. The roller-generator (1) is fabricated with appropriate construction materials to function in continuous operation with little maintenance in a single roadway, or a divided highway (5) in either the fast (2) or slow (3) lanes, but more preferably in the fast lane (2).

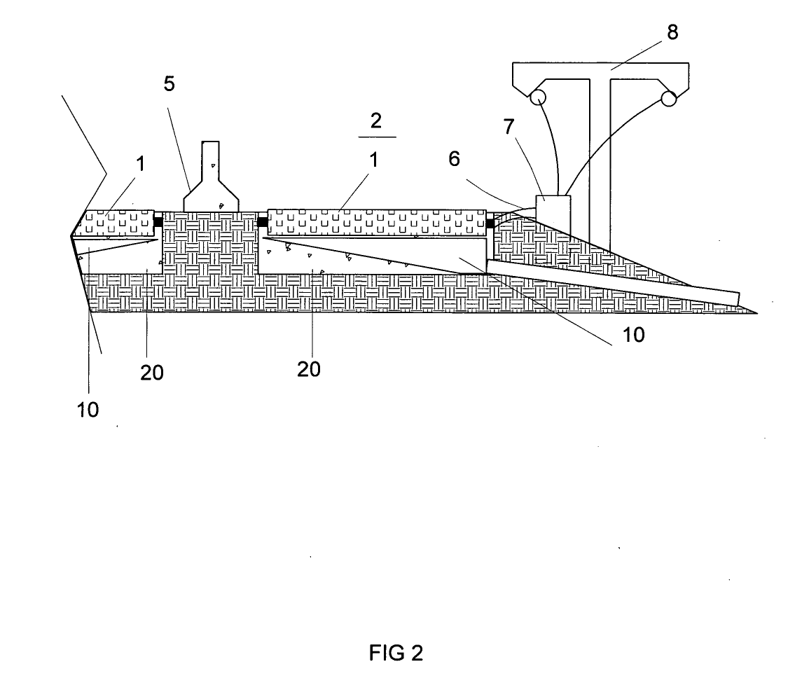

FIG. 2 is an elevation of a lane of a divided roadway (5) showing friction roller-generators (1) installed therein. As shown in FIG. 2, the unit is contained in a housing compartment (20) beneath the road, the design of which will support a variety of vehicles encountered on the roadways, including light cars to 100,000 lb trucks. The design of the electrical generator portion of the friction roller (1) and the amount of power generated is a function of the physical size of the friction roller in diameter and length. The diameter of the roller ranges from 4-inches to 48-inches, but preferably 12 to 24 inches, depending on the geometry of the placement area in the road and the road type. The length of the roller is a function of the roadway dimensions and the generator design. The number of rollers will depend upon how much space is available and the amount of generated power needed at the desired location.

Referring to FIG. 2, the power generating system that transfers vehicular movement into rotational energy consists of utilizing a section of road (2) with an underground containment system (20) to support and house one or more roller-generators (1). The underground housing compartment (20) is designed to support the roller-generator (1). The sediment and water catch basin (10) is designed to keep the roller-generator (1) clean in undesirable weather conditions. The catch basin (10) is elevated at one end to accommodate removal of water and sediment from the roller-generator by draining it to the side of the road. The concept of a self contained system for removal of road debris and draining water out of the containment area is an expanded feature of this invention, over that revealed in the prior art U.S. Pat. No. 3,885,165.

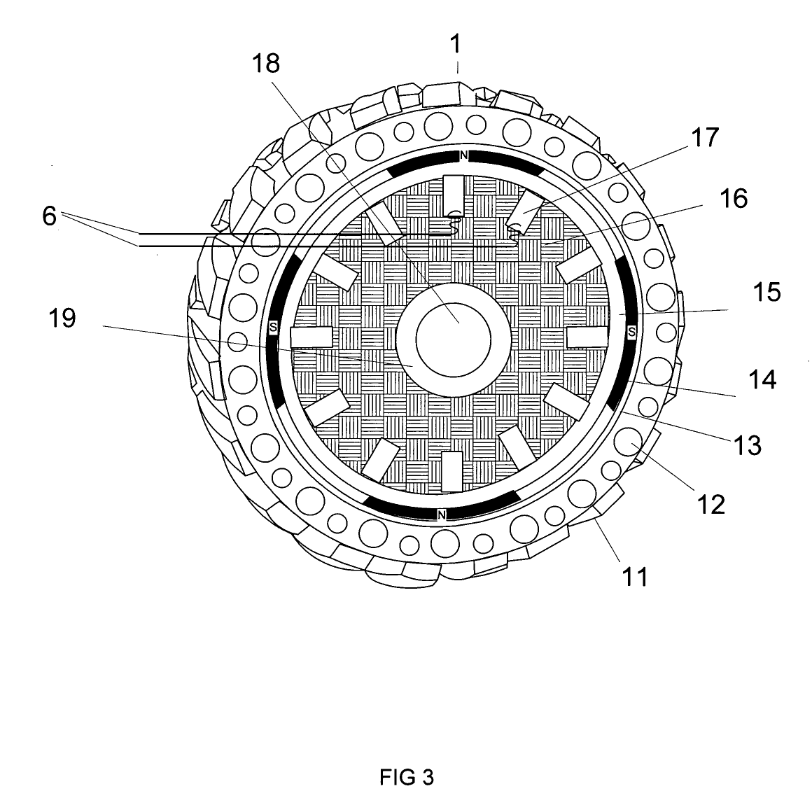

FIG. 3 is a cross sectional view of the friction roller-generator (1) used to convert vehicle motion into electrical power. There are many types of generators which produce either direct or alternating current. Specific generator selection and details of the design will depend on the location, type of installation and power requirements. What is important is that there is relative motion between the adjacent field and the armature. Direct current generators can operate at any speed which makes them suitable to the application in this invention. Some basic design considerations for the selection of an optimum direct current generator for this application are conventional brushed direct current generator, the inside out brushed direct current generator and the conventional homopolar (HPG) designs. Brushless direct current generator technology with electronic commutation is also available depending on design requirements. This invention is not limited to generators which use brushes.

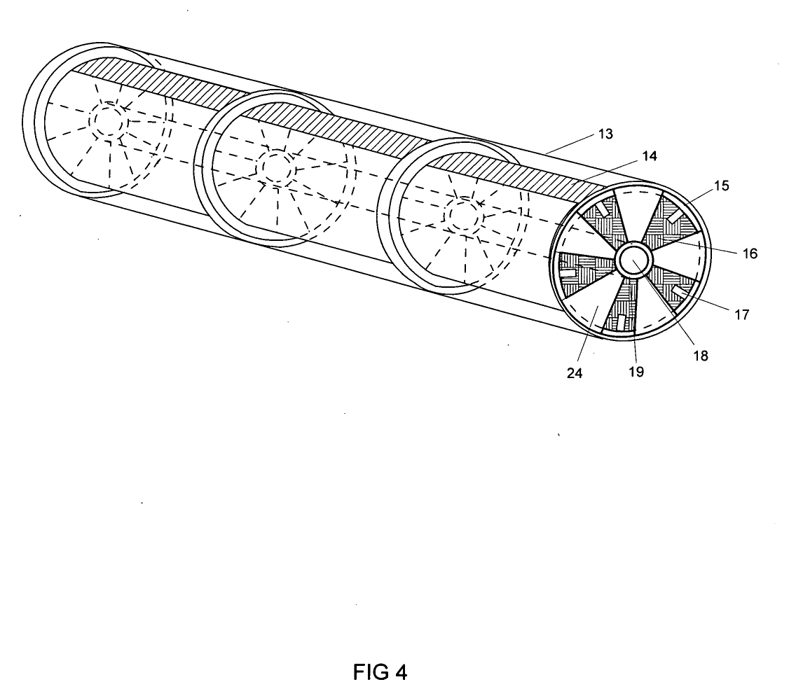

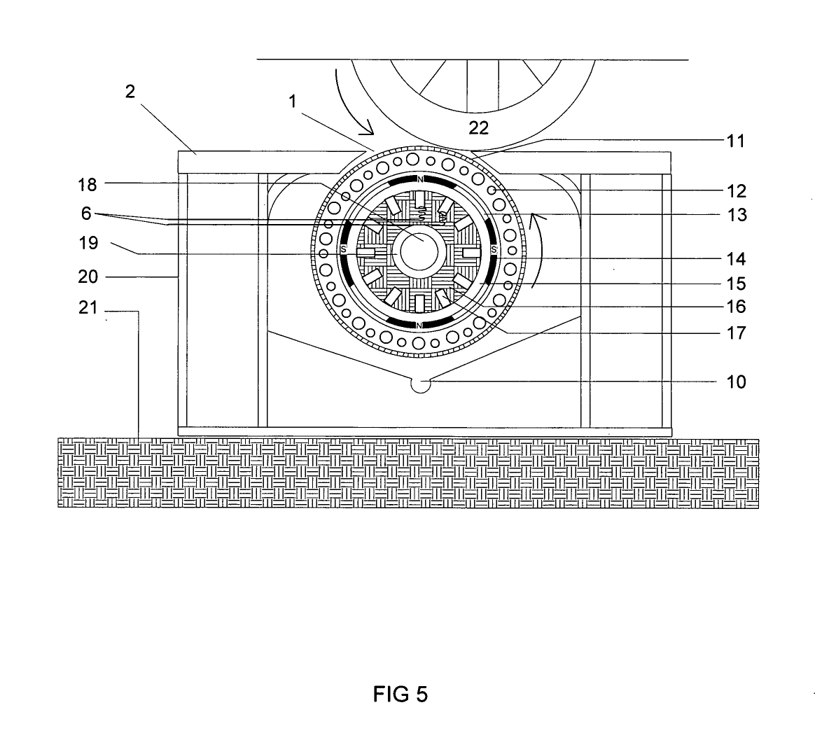

The example illustrated in FIG. 3, uses a brushless direct current generator design with a rectifier system to eliminate the use of brushes for commutation, while performing the same function as a commutator in a conventional generator. Power leads (6) connect the rectified direct current output to an external electrical device or power grid. The rotor (14), containing four permanent magnets provides the brushless rotating field excitation. The electrical stator or armature winding (16) is made up of a number of evenly distributed coil slots (17). The outer roller shell (13) is metal which serves as the rotor for the generator to which are attached the permanent magnets (14) that provide the excitation field. An air gap (15) separates the rotating field windings (14) from the stationary armature (16) which is in the core of the roller. The armature (16) and the permanent magnets (14) extend the length of the roller (13). The roller-generator is mounted upon a center support shaft (18) which is journaled in a sealed bearing (19) attached to a support hub (24) as shown in FIG. 4. The entire assembly is suitably embedded in an underground housing (20) formed in the roadway as shown in FIG. 5. The concept of a combined roller-generator is a novel feature of this invention, not revealed in the prior art.

As shown in FIG. 3, another embodiment of this invention is a molded compressible polymer tread covering (11) attached to the outside of the metal roller (13) which covers the entire surface along the length of the roller. Embedded within the polymer cover (11) are air compression chambers (12) which compress when a vehicle tire rolls over them. The compressible polymer cushions the vehicle impact, and smoothes out potential bumps due to the roller extended above the road surface. This tread design increases traction between vehicle (9) and roller (1) and facilitates removal of water and sediment. Covering the roller with a polymer tread minimizes the prior art “bump” disadvantage and improves the roller efficiency. The concept of a compressible roller cover is a novel feature of this invention, not revealed in the prior art.

Another embodiment of this invention is the use of a single friction roller-generator with multiple support hubs separating multiple armatures (16) as shown in the perspective view of FIG. 4. In a single rotation, power is transferred from each stationary armature fixed on a common shaft, and coupled together between support hubs (24) attached to the metal roller (13). The rotating hub (24) is attached to a shaft (18) which is journaled in heavy conventional bearings (19). The entire assembly is embedded and supported in a housing compartment (20) inside the transverse channel in the roadway. The concept of using a single friction roller-generator or multiple friction roller-generators is a function of many variables; power requirements, physical generator design limitations, roadway surface and location, mechanical and maintenance issues.

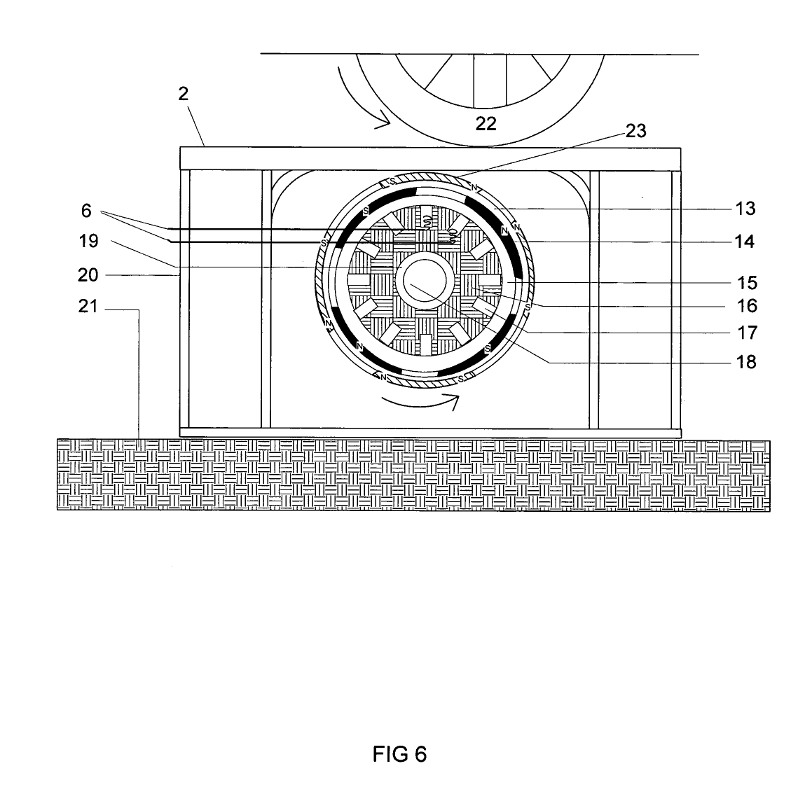

Applications of this invention are shown in FIGS. 5 and 6. FIG. 5 is a cross-sectional view of the friction roller-generator (1) in an underground compartment (20) below the road which is partially enclosed similar to U.S. Pat. No. 3,885,165. The friction roller-generator (1) is housed within the encased channel (20) which is level with the surface of the road (2) and extends transversely across at least one lane of the road, preferably the fast lane. In this example, instead of using an external generator coupled to a roller to produce electrical power, the generator this invention utilizes a roller with the built-in generator of the present invention to directly produce electrical power. The generator is an integral part of the roller. Direct current output voltage is generated by a multiphase brushless generator and a rectifier bridge, and can be connected via power leads (6) to an external electrical device and/or inverted to alternating current voltage and sent to a power grid. The generator comprises a magnetic excitation field containing adjacent magnets (14) of opposite polarity built into the metal roller shell (13). The magnets rotate around a stationary armature (16) consisting of a suitable number of coil slots (17) which establishes a magnetic field distribution in the air gap (15) around the periphery of the stationary armature (16). The roller-generator (1) is exposed above the road surface (2) about ⅛-inch to 3-inches, more preferably, ½-inch to 1-inch. The generator is activated by a passing motor vehicle's car tires (22) coming in contact with the exposed roller compressible polymer tread surface (11), thereby causing rotation and producing electrical power. The present invention when used in a partially encased channel will function in undesirable weather conditions. Drainage channels (10) below the roller device remove water and debris that filters through the openings between the roller surface and the road and directs it to the side of the road.

FIG. 6 is an example of a cross-sectional view of a magnetized cylindrical roller-generator which is completely sealed within a housing compartment (20) below the road surface (2), similar to U.S. Pat. No. 4,247,785. In this example, instead of using a coupled external generator, this invention utilizes a roller with a built-in generator as described in the present invention to produce electrical power. The exterior of the roller-generator shell (13) is fitted with a strong outer shell magnetic lining (23) embedded along the roller's axis at optimum distances apart as described in U.S. Pat. No. 4,247,785. A passing motor vehicle largely made of magnetic material, or enhanced by additional magnets mounted within the vehicle body, would cause the roller-generator to rotate due to the magnetic interaction between the rotary device and the vehicle. Using this configuration, the polymer traction cover is not required since the roller-generator is completely enclosed below the road surface and its outer shell is lined with magnets.

The generated power from any of the above examples can be transmitted to a storage battery, electrical device or converted from direct current to alternating current by use of an inverter and sent directly to a power grid. Alternatively, the power generated can used to operate lights or other electrical devices directly on site, resulting in an independent electrical system. The aforementioned invention is best placed in areas of high traffic volume.

We claim:

1. A system for generating useful clean electrical power from the passage of a motor vehicle over a roadway surface comprising:
at least one cylindrical friction roller embedded in said roadway slightly protruding above said road surface or encased completely below said road surface depending upon the choice of encased design;
a power generator built into the friction roller for converting the rotational motion from a vehicle passing over the roller directly into electric power;
at least one transverse channel under said road extending across at least one lane of said road, preferably the fast lane;
a friction roller, power generator device in said channel positioned with its rotary axis transverse to the road and extending across at least one lane of said road;
an underground containment system housing said channel and friction roller-generator;
a power conversion means to connect the friction roller-generator to a storage battery and/or inverter to supply electricity to a power grid.

2. An apparatus according to claim 1 wherein said cylindrical roller-generator for converting vehicular motion into rotational energy and into electrical energy is an electric power generator.

3. A generator defined in claim 2 wherein the electric generator is a rotating electromagnetic generator capable of producing direct current or alternating current by means of a power inverter;

4. Wherein the underground containment system of claim 1 may be partially or totally enclosed depending upon the type of roller-generator design;

5. A cylindrical metal friction roller-generator comprising:
a heavy polymer traction cover bonded onto the roller and extending transversely across the entire surface of the roller;
a multiplicity of air compression chambers embedded within the traction cover which compress when a vehicle tire rolls over them.

6. The air compression chambers of claim 5 whereby said air compression chambers cushion the vehicle impact and smooth out potential bumps from the roller-generator extending above the road surface.

7. The traction cover of claim 5 whereby the molded rubber tread surface design increases friction between the vehicle tire and the roller surface for improved contact and facilitates removal of water and debris.

8. A partially enclosed underground containment system of claim 4 comprising:
an inclined smooth plane surface beneath the roller-generator to collect contaminants such as water and debris;
a channel to drain said water and debris from the road surface to the side of the said road;

9. A roller power-generator of claim 1 wherein for the same road type and roller revolutions will produce electricity more efficiently than a roller coupled to a generator as utilized in the prior art (U.S. Pat. No. 4,247,785, U.S. Pat. No. 3,885,165).
